(19) United States
(12) Patent Application Publication
(10) Pub. No.: US 2012/0054081 A1
(43) Pub. Date: Mar. 1, 2012

(54) RECOVERY FROM PARTICIPANT DEFAULT IN A SECURITIES LENDING TRANSACTION

(75) Inventors: Gregory Wayne DePETRIS, Guilford, CT (US); Martin Rein Hakkar, Northport, NY (US); Thomas Walter Little, JR., New York, NY (US)

(73) Assignee: Automated Equity Finance Markets, Inc., New York, NY (US)

(21) Appl. No.: 12/862,009

(22) Filed: Aug. 24, 2010

(51) Int. Cl. G06Q 40/00

(52) U.S. Cl. 705/37

(57) ABSTRACT

A stock loan system enables a non-clearing member lender to lend to a non-clearing member borrower; each of the non-clearing members is associated with a respective clearing member. When a clearing member defaults, the stock loan system automatically tries to reassign the loan to a backup clearing member, or if no backup clearing member is available, the stock loan system automatically terminates the stock loan, thereby avoiding the loan being in a legal limbo due to the default of the clearing member.

### BACKGROUND OF THE INVENTION

The present invention relates to processing of securities lending transactions, in particular, stock loans after a participant in the stock loan has defaulted.

After a securities trade occurs, either manually (via telephone call) or via a trading platform, the trade goes to post-trade processing, namely, clearance and settlement. Clearance is the verification of information between the two brokers in a securities transaction. Settlement is the process whereby securities are delivered, usually against payment, to fulfill the trade.

When the trade is a stock loan, there is a risk that one of the parties to the trade will become insolvent and default. At present, there is no automated method for recovering from the default. Instead, a government regulatory agency, the Securities Investors Protection Corporation (SIPC) steps in and covers up to $500,000 per account. However, it typically takes months or years for SIPC to sort things out, which can be extremely troublesome to the non-defaulting parties.

Accordingly, there is a need for a way to automatically recover from participant default in a securities transaction, particularly a stock loan.

### SUMMARY OF THE INVENTION

In accordance with the present invention, there is provided a method for processing a stock loan having a non-clearing member associated with an original clearing member. A notice is received at a computer that the original clearing member has defaulted, and the computer checks whether the non-clearing member has a backup clearing member. When the non-clearing member has a backup clearing member, the computer automatically reassigns the stock loan to the backup clearing member, and when the non-clearing member lacks a backup clearing member, the computer automatically terminates the stock loan.

In accordance with another aspect of the present invention, there is provided a method for processing a stock loan having a non-clearing member associated with an original clearing member. A computer receives a notice that the original clearing member has defaulted, and the computer automatically reassigns the stock loan to a backup clearing member.

In accordance with a further aspect of the present invention, there is provided a method for processing a stock loan having a non-clearing member associated with an original clearing member. A computer receives a notice that the original clearing member has defaulted, and the computer automatically terminates the stock loan.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing the conventional formation of a securities loan;

FIG. 2 is a block diagram showing the conventional formation of a securities loan with central clearing party;

FIG. 3 is a block diagram showing an automated loan market system;

FIGS. 4A and 4B are flowcharts showing formation of a securities loan with the automated loan market system;

FIGS. 5A-5C are diagrams showing the legal relationships for a stock loan;

FIGS. 6A-6B are diagrams showing the relationship between a clearing member account and its associated sub-accounts;

FIGS. 7A-7C are a flowchart showing processing when a clearing member default occurs;

FIG. 8 is a flowchart showing forced buy-in processing;

FIG. 9 is a flowchart showing forced sell-out processing; and

FIGS. 10A-10C are a flowchart showing the scenario of a default by CM-Borrower.

### DETAILED DESCRIPTION

The conventional U.S. securities lending marketplace will now be discussed.

A normal or “long” sale is the sale of a security that the seller presently owns.

A “short” sale is the sale of a security that the seller does not own or any sale that is consummated by the delivery of a security borrowed by, or for the account of, the seller. Usually, a short seller expects the market price for a security to decrease; a short seller sells now, expecting to buy at a lower price in the future to close out her position. This is a profitable strategy when it achieves the sequence of sell high then buy low. The ability to engage in short selling is crucial for effective arbitrage. Short sellers generally do not know the duration of time they will maintain their position.

Short sellers include hedge funds, mutual funds (if permitted by the rules of the fund), institutional investors, retail investors, brokers trading for their own account, arbitrageurs, market makers, risk managers, speculators, and so on.

Securities lending contributes to the overall liquidity and efficiency of equity and equity options markets.

The most common reason that someone wants to borrow securities is to accomplish or facilitate a short sale in compliance with the Securities and Exchange Commission (SEC) regulations. Specifically, SEC Regulation SHO requires short sellers in all equity securities to locate securities to borrow before selling, see http://www.sec.gov/rules/final/34-50103.htm. Other reasons for borrowing securities, referred to as “permitted purposes” under Regulation T of the Board of Governors of the Federal Reserve System, include (i) to prevent a settlement failure, and (ii) for establishing an Exchange Traded Fund (ETF). The permitted purpose need not be accomplished by one of the parties, but must occur somewhere in an associated transaction. Firms with a large number of active retail accounts and substantial revenue are exempt from the permitted purpose regulation and so can borrow for any reason.

For options market participants, securities lending supports market making, arbitrage trading, equity financing and assists participants in meeting deliveries resulting from options exercises and assignments.

Securities lenders, or their agents, are parties that presently own the security. The legal owner of a security is referred to as the “beneficial owner”. Lenders wish to lend to make profit on their securities inventories that are otherwise idle. Custody banks are the largest lenders in the US market, lending as agents on behalf of large institutional owners such as pension funds, public retirement funds, mutual funds and endowments. Additionally, brokers want to lend to enable their customers to accomplish short sales. Securities lending and margin finance are responsible for over half of prime brokerage revenues. At end 2007, US$2.1 trillion of equities were on loan in U.S. markets.

If not for certain “Prohibited Transaction Exemptions” issued by the U.S. Department of Labor, employee benefit plans would refrain from lending to avoid violating provisions of the Employee Retirement Income Security Act of 1974 (“ERISA”).

A short sale consists of a trader selling stock that the trader does not own on trade day (T), and delivering borrowed stock on settlement day, which is the third day after the trade day (T+3). Eventually, the trader closes her position by buying stock, and terminating the stock loan. That is, the trade occurs on T, while the stock loan occurs on T+3. The trade settlement also occurs on T+3.

To bridge the time difference between T and T+3, “locate” practice is used in the securities industry. A locate is an affirmative determination that a party will provide the named quantity of securities three days hence.

A trader can obtain a locate by asking a broker, such as by telephone, email or instant message, or by consulting a locate file provided by the broker to the trader each morning, listing the inventory that the broker has available to loan. Not all locates are actually converted into loans. Reasons for non-conversion include that the stock is either not needed as the short seller closed her position prior to T+3 or that the stock was actually loaned by a party other than the locate provider.

A broker maintains lendable securities inventories when the broker trades for its own account, and when the broker holds securities on behalf of the margin accounts of customers who have bought the securities. Section 8 of the Exchange Act of 1934 prohibits brokers from lending shares held in retail cash accounts or retail non-margin accounts. Usually, when a retail customer opens a brokerage account, the terms of the account permit the broker to re-hypothecate and lend securities that the customer holds.

In exchange for a loan, the customer provides cash collateral in an amount slightly greater than the value of the securities, such as $102 of cash for each $100 of securities value. The broker pays interest to the securities borrower on the cash collateral. The “rebate rate” is the interest rate paid for the cash collateral. Negative rebates can and do occur, corresponding to expensive loans.

A securities loan is for a period of one-day and is self-renewing (“overnight self-renewing”) unless either (a) the borrower returns the shares of the security, or (b) the lender recalls the shares of the security.

If the value of the security fluctuates, the amount of required cash collateral correspondingly fluctuates, so the borrower may have to supply more margin (usually money) or may receive margin back.

If the broker lacks its own inventory to make a securities loan, the broker finds a lender, then the broker enters into a first securities loan contract with the lender, and then enters into a second securities loan contract with the borrower. The terms of the loan contracts are different, usually providing profit to the broker for its services in arranging the loan.

Generally, the loans have standardized terms and conditions, but the interest rates are different depending on the relationships between the parties (long-standing relationship vs. first transaction), the amount of stock being loaned (small loans tend to be more expensive per share) and the characteristics of the security (readily available vs. hard to find) (amount of general collateral stock relative to amount of non-general collateral stock), and so on.

In the U.S., the Securities Industry and Financial Markets Association (SIFMA) provides and updates standardized terms for securities loans as the Master Securities Loan Agreement (MSLA), available at www.sifma.org/services/stdforms/pdf/master_securities_loan_agreement_{—}2000_version.pdf

In Europe, the International Securities Lending Association (ISLA) provides an updates standardized terms for securities loans as the Global Master Securities Loan Agreement (GMSLA), available at http://www.isla.co.uk/docs/Gmsla%202000%20version.doc.

A conventional stock loan involves four parties. On the lender side, there are agent-lenders, such as a custodian bank for a pension fund, and broker-dealers who represent the agent-lenders. On the borrow side, there are borrowers, such as a hedge fund, and broker-dealers who represent the borrowers.

In some cases, the agent-lender auctions the exclusive right to borrow its portfolio of securities to a single broker-dealer, at a first interest rate. Then, the broker-dealer lends the portfolio at a second interest rate. When the first interest rate is different than the second interest rate, the agent-lender is not getting the full economic value of its portfolio.

Similarly, the borrower borrows from a broker-dealer at a first rate (which could be different than the first rate between the agent-lender and the lender's broker-dealer). The borrower's broker-dealer borrows, at a second rate, from its own inventory or another broker-dealer's inventory.

The price of a stock loan means the interest rate paid to the borrower on the cash collateral posted to the lender. The borrower is not actually paying anything, but rather, choosing to accept more or less interest on the collateral.

From the borrower's perspective, “to pay more” means to accept a low interest rate on the loan. For easy to borrow, widely available securities, borrowers expect to be paid higher interest rates on their cash collateral. The borrower has some choices for sources of the stock, and is thus unwilling to pay a premium for the inventory.

From the lender's perspective, “to pay more” means to pay higher interest on the collateral. Lenders expect to pay higher interest rates when loaning very liquid securities. Ultimately, the lender profits are the difference between the cash reinvestment rate they earn internally relative to the rate paid to the borrower, or the difference between the interest rate the lender borrowed the stock at, and the rate they lend it at. In either case, a profit-maximizing lender chooses to offer securities at the lowest market clearing interest rate.

The difference in borrowing rates, referred to as the spread, represents profit for the broker-dealer. A broker-dealer can make profit (or loss) from the difference in cash collateral between the first and second loans, and from the difference in interest paid on the cash collateral between the first and second loans.

The broker-dealers have a network of bilateral relationships, and typically trade with only other broker-dealers that they trust. Sometimes, a broker-dealer can fulfill its client's request to borrow or lend from its own inventory, and so another broker-dealer is not necessary. The broker-dealers are often members of a clearing corporation and/or a depository corporation, so they can readily effectuate clearance and settlement. As used herein, a broker-dealer is assumed to be a member of a clearing corporation and also a depository corporation. The agent-lenders and borrowers are not clearing members, as they prefer not to comply with the capital requirements and regulatory restrictions needed to be members.

Broker-dealers communicate with each other through a variety of means, such as telephone, instant messaging, email, and so on, as is convenient for any particular pair of broker-dealers.

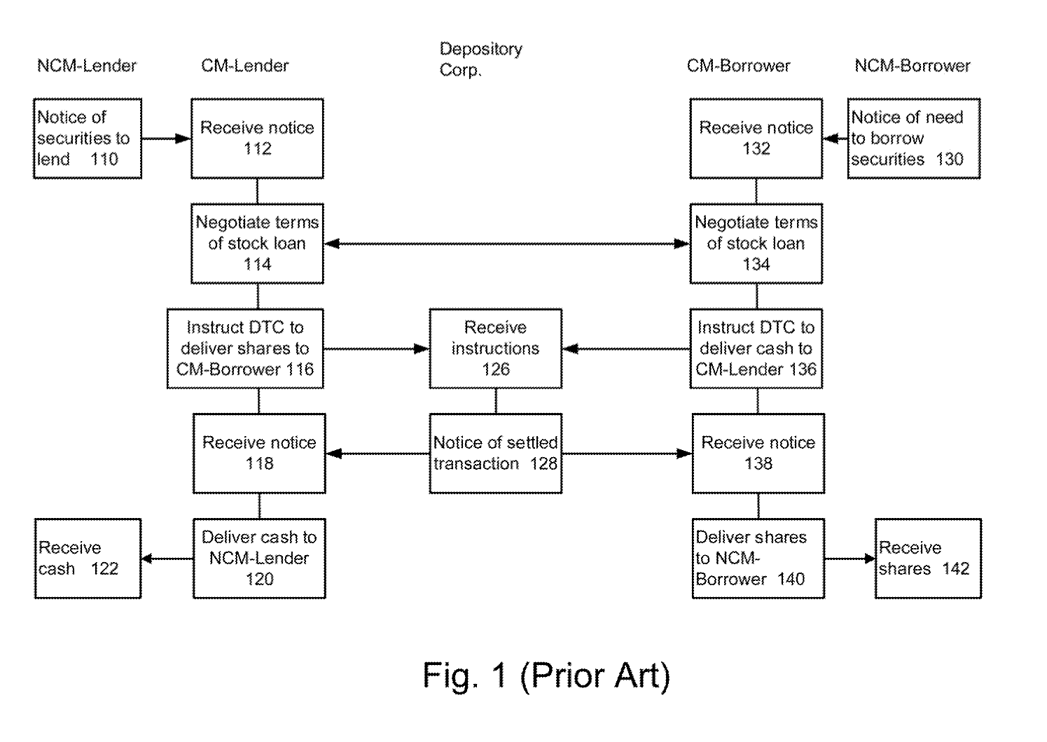

FIG. 1 is a block diagram showing the conventional formation of a securities loan. In this conventional arrangement, a key distinction is between clearing members, who are members of depository corporation that has physical possession of securities, and non-clearing members, who are not members of the depository corporation and thus cannot clear their own trades. In this conventional arrangement, each clearing member is its own clearing agent.

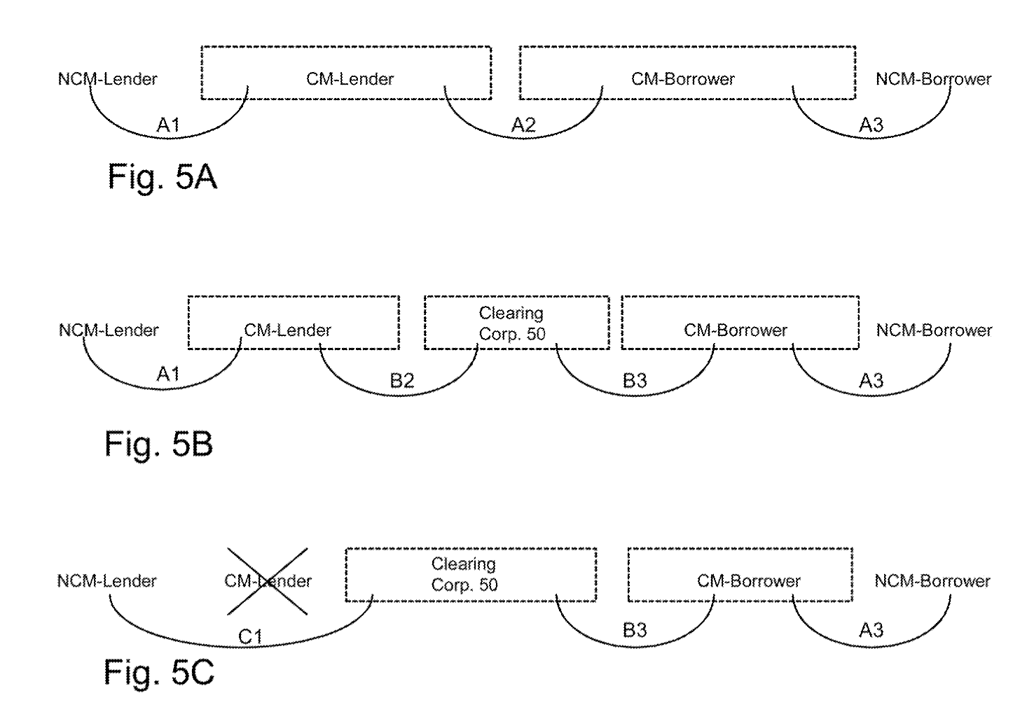

At step 110, the agent-lender, indicated as NCM-Lender, advises its broker-dealer, referred to as CM-Lender, that it has securities to lend. As mentioned, this notice may be an auction for exclusive rights to the NCM-Lender's securities portfolio. At step 112, CM-Lender receives the notice and agrees on loan terms, forming a first contract shown as A1 in FIG. 5A. NCM-Lender makes its shares available for lending by CM-Lender at a depository corporation, such as Depository Trust Corporation (DTC).

The agent-lender typically maintains insurance to indemnify its customers (pension funds) against the risk of default by its counter-party.

At step 130, the borrower, indicated as NCM-Borrower, notifies its broker-dealer, referred to as CM-Borrower, that it wishes to borrow securities, typically to execute a short sale.

At step 132, CM-Borrower receives the notice and agrees on loan terms, forming a second contract shown as A3 in FIG. 5A. NCM-Borrower delivers cash or other collateral to DTC generally directly, i.e., not via CM-Borrower, for the account of CM-Borrower, such as $102 cash per $100 of securities value.

At step 112, CM-Lender offers to lend to CM-Borrower. At step 134, CM-Borrower agrees to borrow from CM-Lender. The broker-dealers agree on terms, typically the interest rate, thereby forming a third contract shown as A2 in FIG. 5A. The interest is computed and credited to borrower 10 on a daily basis. The interest is expressed relative to the Federal Funds (FF) overnight interest rate, i.e., FF minus bb basis points.

At step 116, CM-Lender instructs DTC to deliver shares from the account of CM-Lender to the account of CM-Borrower.

At step 136, CM-Borrower instructs DTC to deliver cash from the account of CM-Borrower to the account of CM-Lender.

At step 126, DTC receives the instructions from CM-Lender and CM-Borrower, and moves the securities and cash to the proper accounts. At step 128, DTC notifies CM-Lender and CM-Borrower that the transaction has settled.

At step 118, CM-Lender receives the settlement notice, and at step 120, delivers the cash from CM-Borrower to NCM-Lender. At step 122, NCM-Lender receives the cash, and typically invests the received cash.

At step 138, CM-Borrower receives the settlement notice, and at step 140, delivers the securities from CM-Lender to NCM-Borrower. At step 142, NCM-Borrower receives the stock, and typically uses it to fulfill a short sale collateral requirement.

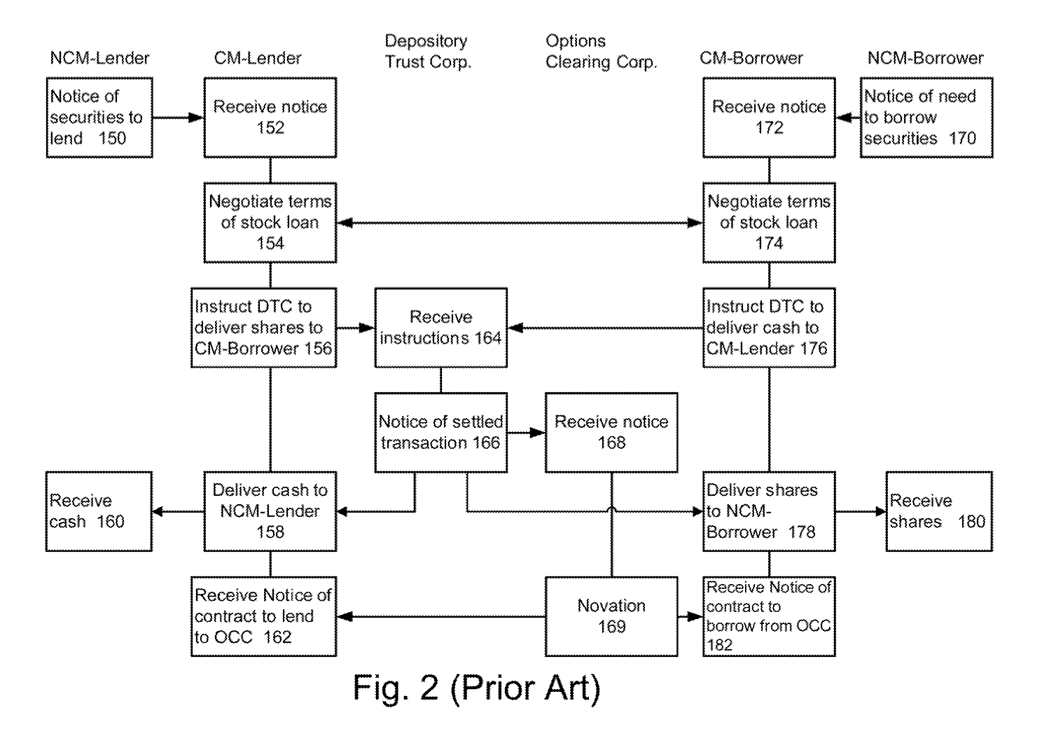

FIG. 2 is a block diagram showing the conventional formation of a securities loan with a central clearing party.

A small amount of the securities loan market occurs in a centralized clearinghouse environment called the Options Clearing Corporation (OCC) Stock Loan Program, a trade reporting facility that allows OCC's clearing members to use borrowed and loaned securities to reduce OCC margin requirements. In this program, the loan is legally between the borrower and lender, that is, non-anonymous, and OCC guarantees mark-to-market payment of stock loans between the program participants. This program is depicted in FIG. 2.

Steps 150, 152, 154, 156, 158, 160, 164, 166 of FIG. 2 correspond to steps 110, 112, 114, 116, 118, 120, 122, 126, 128, respectively, of FIG. 1 and are not discussed for brevity. Steps 170, 172, 174, 176, 178, 180 of FIG. 2 correspond to steps 130, 132, 134, 16, 138, 140, respectively, of FIG. 1 and are not discussed for brevity.

At step 168, OCC receives notice of the settled transaction. At step 169, OCC performs a novation, substituting two contracts, shown as B2 and B3 in FIG. 5B, for the contract shown as A2 in FIG. 5A. Specifically, for the contract between CM-Lender and CM-Borrower (contract A2), OCC substitutes a contract between CM-Lender and OCC (contract B2) and a contract between OCC and CM-Borrower (contract B3), and sends notice of these contracts to CM-Lender and CM-Borrower. At step 162, CM-Lender receives the notice of the novated contract. At step 182, CM-Borrower receives the notice of the novated contract.

OCC financial safeguards include (i) initial required capital for its members, (ii) on-going minimum net capital for its members, (iii) updated margin requirements for its members based on their trading positions, for protection in the event of member default, (iv) a clearing fund proportional to the size and volatility of positions guaranteed by OCC, funded by participants in the guarantee program, and (v) assessment rights against its members, up to their original contribution to the clearing funds should it be depleted.

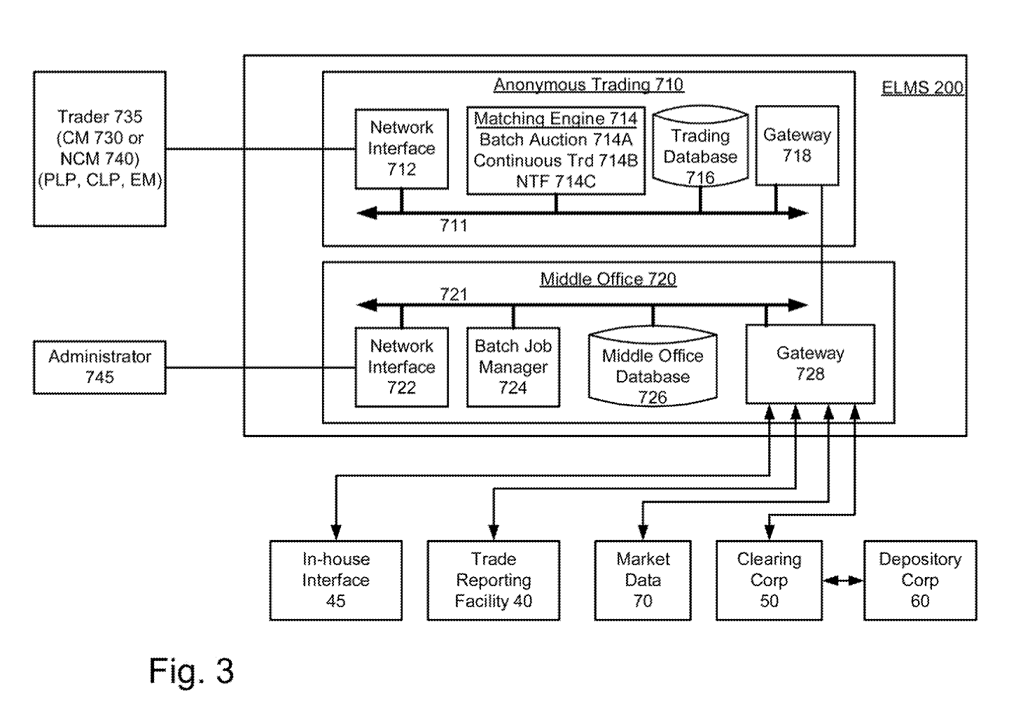

FIG. 3 is a block diagram showing an automated loan market system, electronic loan market system 200. ELMS 200 provides greater transparency and enhanced price discovery to the stock loan market, and reduces systemic risk. In this arrangement, each clearing member uses a clearing corporation as its clearing agent to enable anonymous trading.

ELMS 200 is a computer system having one or more general purpose computers executing software for performing its functions, as discussed below, along with suitable communication facilities for its users, also referred to as market participants, specifically stock lenders, stock borrowers, their sponsoring clearing members and suitable memory and storage.

A lender is classified as one of a primary liquidity provider (PLP), a competitive liquidity provider (CLP) or an electronic participant (EP) 250. Initially, a lender is assigned to one of these three categories, and over time, if the lender does not conform to the behavior required for the category, the lender may have its permissions and capabilities adjusted or may be re-assigned to another category. The lenders in each category are also ranked within the category. In other embodiments, different categories may lie provided, such as a further category PLP+.

A borrower is one of a CLP and an EP. By definition of a PLP, a PLP is only a lender. Examples of a PLP include insurance companies and pension funds. ELMS 200 is configured to support a primary market and a secondary market, as described in U.S. patent application Ser. No. 12/321,600, the disclosure of which is incorporated herein in its entirety. An EP is permitted to lend only in the secondary market. A CLP entity can be either a lender or a borrower over the course of its life, but in a particular transaction it assumes one role.

Borrowers generally request a loan to either (i) refinance an existing (already settled) short position, or (ii) provide inventory for an executed short order that is settling.

ELMS 200 maintains a record of available inventory, by security. A borrower sends a loan request to ELMS 200 and, after competing for the loan in ELMS 200, receives a loan commitment and a locate ID.

Securities loans arranged through ELMS 200 are automatically reported by ELMS 200 to trade reporting facility 40 and clearing entity 50. ELMS 200 also provides a facility (not shown) for its participants to report manually negotiated securities loans to trade reporting facility 40 and clearing entity 50.

Trade reporting facility 40 may be an existing processing service such as Equilend or Loanet. Trade reporting facility 40 receives trade reports from ELMS 200, because some entities may be using ELMS 200 for only part of their trading activity, and wish to use trade reporting facility 40 to have a full record of all of their trading activity.

In-house interface 45 is adapted to report trading activity to in-house systems of CMs and NCMs for presentation to users of these in-house systems.

Clearing corp. 50 may be one or more of Options Clearing Corporation (OCC), Depository Trust Clearing Corporation (DTCC), National Securities Clearing Corporation (NSCC), Boston Stock Exchange Clearing Corporation, Philadelphia Stock Exchange Clearing Corporation, or other suitable SEC regulated CA-1 facility that can clear security trades.

Clearing corp. 50 obviates the conventional privity between borrower and lender. Privity is a direct relationship between parties to a contract or transaction sufficient to support a legal claim. Benefits include: (i) operationally simpler—no separate loan agreement for each loan; (ii) more cost effective—reduced legal costs; and (iii) anonymity. Because ELMS 200 is involved in arranging each transaction, it can allocate activity according to an incentive system, and can be structured to facilitate incentives.

Clearing corp. 50 requires each of its clearing members to maintain a cash balance, referred to as “margin” with clearing corp. 50. The margin requirement for a CM depends on its net position, summed over all of its sub-accounts. The margin requirement generally is determined by the market price of securities, the market risk of the net positions, and the excess collateral requirements imposed on borrowers by lenders, such as the 102% cash collateral.

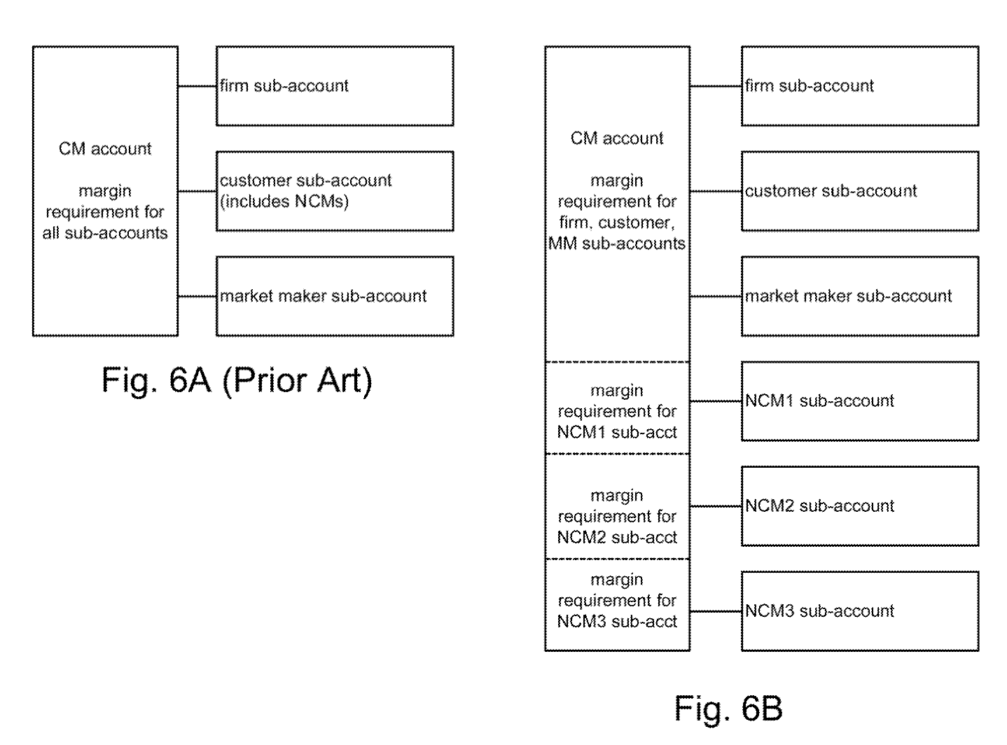

FIG. 6A shows that a CM typically has a sub-account for its own trades, a sub-account for customer trades, and a sub-account for its trades as market maker. The CM may have one, two or all three of these sub-accounts.

Depository corp. 60 maintains accounts for its members, and transfers shares and cash collateral in accordance with trade reports submitted by or on behalf of its members.

ELMS 200 arranges and records loans. Clearing entity 50 is the counterparty to each loan. The original counter-party is anonymous, and anonymity is maintained as clearing entity 50 becomes the counter-party through a novation, discussed below.

Trader 435 is one of a PLP, a CLP, and an EP, and has the status of a clearing member (CM) or a non-clearing member (NCM) affiliated with a CM. A trader can trade for a trading account.

A NCM must designate a sponsoring CM for each order submitted to ELMS 200.

A CM can monitor, on a real-time basis, the activities of NCMs that it sponsors. A CM can supervise its NCMs by some or all of the following: (1) setting and modifying gross and net credit limits, (2) adding and removing restrictions for entering and modifying orders, (3) approving trading activity on a trade-by-trade basis, and (4) entering position limits to govern pre-approved trading for their NCMs.

Administrator 745 is an administrative employee of a CM or a NCM, that is, administrator 745 is not a trader. A NCM administrator can set credit limits for particular traders, set passwords, and assign roles for other users within the NCM's organization. A CM administrator can perform the previously described functions for its CM traders, and can set credit limits for its NCMs, and can approve CM and NCM activity.

As used herein and in the claims, formation of a stock loan is synonymous with creating a stock loan trade, also referred to as a stock loan transaction, and is also synonymous with matching a borrower and lender to form a stock loan.

As used herein and in the claims, for purposes of a stock loan, a lender corresponds to a seller while a borrower corresponds to a buyer.

Although the capabilities of ELMS 200 are described with respect to stock loan, these capabilities are not limited to stock loans and may be used in other trading activity.

Anonymous trading module 710 may be implemented on a series of server computers sharing a common bus and database. In one embodiment, anonymous trading module 710 is a customized version of the Cinnober TRADExpress Platform, described at www.cinnober.com. Trading bus 711 is connected to network server 712, matching engine 714, trading database 716 and trading gateway 718. Network server 712 is coupled to parties wishing to borrow and lend stock, through any suitable communication network including public and private facilities. Matching engine 714 enables matching stock inventory with stock loan requests via batch auction module 714A, continuous trading module 714B and negotiated trade facility 714C. Trading gateway 718 is connected to middle office module 720.

Middle office module 720 may be implemented on a series of server computers sharing a common bus and database. Middle office bus 721 is connected to network server 722, batch job manager 724, middle office database 726 and middle office gateway 718. Network server 722 is coupled to administrators 745, through any suitable communication network including public and private facilities. Batch job manager 724 implements the post-trade functions discussed below. Middle office gateway 728 is connected to trading module 710, trade reporting facility 40, and to external services 45, market data 70, clearing corp. 50 and depository corp. 60 (via clearing corp. 50).

Middle office module 720 supports anonymous trading module 710 in carrying out the stock loan marketplace post-trade activities, receiving contracts formed by the continuous and batch auction processes described above, and is discussed further below. In one embodiment, middle office module 720 determines payments relating to rebates, mark-to-market of collateral, and payments relating to corporate actions such as dividends, and notifies clearing corp. 50 of its payment determinations. In another embodiment, clearing corp. 50 determines mark-to-market of collateral, and other payments.

When trading module 710 sends a trade report involving an NCM to middle office module 720, trading module 710 appends the CM for the NCM to the trade report.

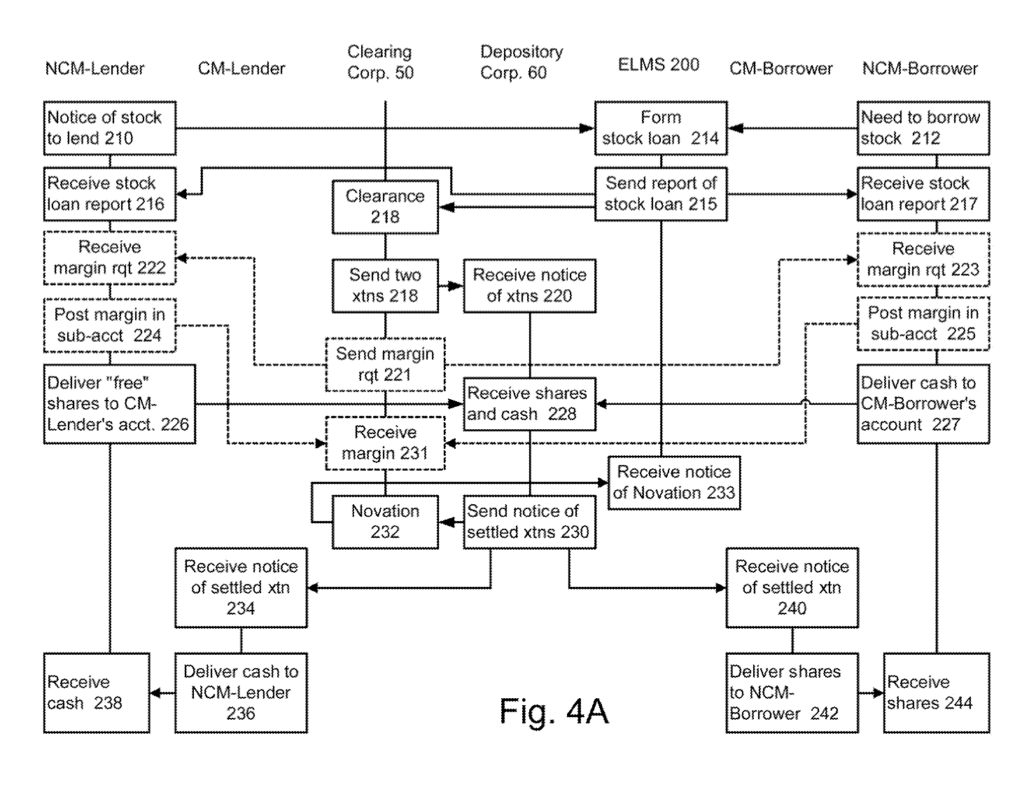

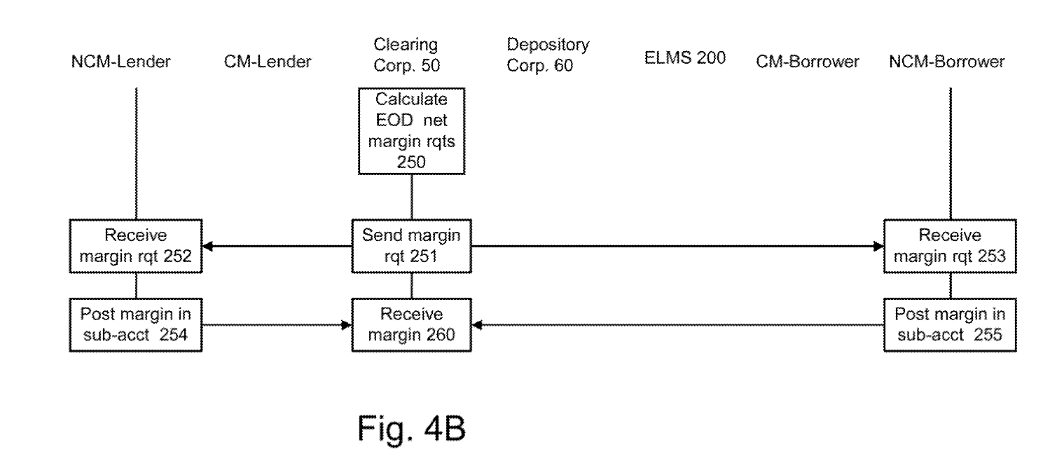

FIGS. 4A and 4B, collectively referred to as FIG. 4, are flowcharts showing formation of a securities loan with the automated loan market system.

Each of NCM-Lender, CM-Lender, CM-Borrower and NCM-Borrower uses ELMS 200 via respective instances of trader terminal 735, shown in FIG. 3. Notices sent to these parties may be sent to trader terminal 735 or to the instance of administrator 745 associated with the party.

Generally, ELMS 200 records all transactions formed via its trading systems, and notifies the party who executed the transaction, with a copy of the notice to the clearing member associated with the executing party, when the executing party is an associated non-clearing member.

At step 210, NCM-Lender notifies ELMS 200 that it has stock to lend via any of the mechanisms supported by matching engine 714.

At step 212, NCM-Borrower notifies ELMS 200 that it wishes to borrow stock.

At step 214, ELMS 200 forms a trade, that is, an agreement to loan stock, via matching engine 714.

At step 215, ELMS 200 sends a trade report for the stock loan to each of the NCM-Borrower and NCM-Lender, and to clearing corp. 50. The trade report includes each NCM and its associated CM. Table 1 shows an example of a trade report, corresponding to contract A2 of FIG. 5A.

TABLE 1

| | |
|---|---|
| Trade Report number | 7366 |
| Borrower ID | 1545 |
| Borrower's CM | 0200 |
| Lender ID | 2788 |
| Lender's CM | 0005 |
| Trade Date | 20090323 |
| Trade Time | 10:42:36 |
| Symbol | XYZ |
| Shares | 100,000 |
| Share Price | 2.50 |
| Contract Amount 100% | 250,000 |
| Collateral Amount 102% | 255,000 |
| FF rate | 2.55 |
| Rebate Rate | −0.07 |
| Mechanism | Continuous Auction |

This trade report indicates that NCM-Lender has an ID of 2788, and CM-Lender has an ID of 0005; that NCM-Borrower has an ID of 1545, and CM-Borrower has an ID of 0200. The trade occurred on Mar. 23, 2009, at 10:42:36 am. The trade is a contract to loan 100,000 shares of XYZ stock having a current share price of 2.50, and thus a contract amount of 5250,000 and a collateral amount of $255,000. The rebate rate is expressed relative to the Fed Funds rate, i.e., 2.55−0.07=2.48%. The trade was formed using the continuous auction mechanism.

At step 216, NCM-Lender receives the stock loan report from ELMS 200.

At step 217, NCM-Borrower receives the stock loan report from ELMS 200.

At step 218, clearing corp. 50 receives the trade report, and generates two corresponding transactions. Tables 2 and 3 show an example of two transactions corresponding to the trade report of Table 1, assuming that the ID for clearing corp. 50 is “0001”. The transaction reports of Tables 2 and 3 correspond to contracts B2 and B3 of FIG. 5B; the transaction reports are merely information and have not yet acquired the status of a legally enforceable contract. Novation, discussed below, is the legally recognized acceptance of the trade reports as contractual obligations of clearing corp. 50. Novation occurs after settlement.

TABLE 2

| | |
|---|---|
| Trade Report number | 7366-1 |
| Borrower ID | 1545 |
| Borrower's CM | 0200 |
| Lender ID | 0001 |
| Lender's CM | 0001 |
| Trade Date | 20090323 |
| Trade Time | 10:42:36 |
| Symbol | XYZ |
| Shares | 100,000 |
| Share Price | 2.50 |
| Contract Amount 100% | 250,000 |
| Collateral Amount 102% | 255,000 |
| FF rate | 2.55 |
| Rebate Rate | −0.07 |

TABLE 3

| | |
|---|---|
| Trade Report number | 7366-2 |
| Borrower ID | 0001 |
| Borrower's CM | 0001 |
| Lender ID | 2788 |
| Lender's CM | 0005 |
| Trade Date | 20090323 |
| Trade Time | 10:42:36 |
| Symbol | XYZ |
| Shares | 100,000 |
| Share Price | 2.50 |
| Contract Amount 100% | 250,000 |
| Collateral Amount 102% | 255,000 |
| FF rate | 2.55 |
| Rebate Rate | −0.07 |

At step 220, clearing corp. 50 sends the two transactions, represented by two trade reports, to depository corp. 60.

To facilitate participant default recovery for NCM participants in ELMS 200, clearing corp. 50 maintains a separate sub-account for each NCM/CM relationship. The benefit of this is discussed below.

FIG. 6B shows that not only does each NCM have its own separately identified sub-account, but also clearing corp. 50 determines the margin requirement for each NCM sub-account separately from the typical CM margin requirement. The NCM has the ability to directly pledge its securities to its sub-account. Clearing corp. 50 uses NCM-Lender's segregated margin assets for mark-to-market and rebate payments, independently from the CM. The CM maintains the rights and responsibilities of the sub-account, that is, if the NCM does not comply with its responsibilities, the CM is ultimately responsible for the NCM's actions. A margin account can hold cash or non-cash collateral. Non-cash collateral is valued at a discount relative to its market value, e.g., a security having a market value of $10 per share is valued at $7 per share in a margin account. If the NCM has insufficient collateral in its sub-account, and does not replenish it upon request, then a default has occurred. In the event of a default, the existing collateral can be seized by clearing corp. 50 and sold.

In practice, margin requirements are determined in an end-of-day process, discussed below with regard to FIG. 4B. For conceptual purposes, the relevant margin events are indicated with dotted lines in FIG. 4A, to explain when the margin requirements legally arise.

At conceptual step 221, clearing corp. 50 determines the margin requirement associated with this trade, and sends a notice of the required adjustment to the margin to NCM-Lender and to NCM-Borrower.

At conceptual step 222, NCM-Lender receives the margin adjustment notice and at conceptual step 224 posts the required margin adjustment to its sub-account with clearing corp. 50. Eligible forms of margin assets include: cash, government securities, government sponsored debt, Canadian government securities, letters of credit, money market funds, valued securities, specific deposits, escrow deposits, and anything else accepted by clearing corp. 50 to satisfy the margin requirement.

At conceptual step 223, NCM-Borrower receives the margin adjustment notice and at conceptual step 225 posts the required margin adjustment to its sub-account with clearing corp. 50.

At conceptual step 231, clearing corp. 50 receives the margin adjustment from NCM-Lender and NCM-Borrower.

At step 226, NCM-Lender responds to the trade report from ELMS 200 by delivering the loaned shares to the account for CM-Lender at depository corp. 60

At step 227, NCM-Borrower responds to the trade report from ELMS 200 by delivering its collateral to the account for CM-Borrower at depository corp. 60.

At step 220, depository corp. 60 receives the two transactions from clearing corp. 50.

At step 228, depository corp. 60 receives the shares and cash collateral corresponding to the two transactions. When the shares and cash are received, the transactions are settled.

In a first phase of settlement, stock is removed from the lender's account and placed into the account for clearing corp. 50, and collateral (cash) is removed from the borrower's account and placed into the account for clearing corp. 50. In a second phase of settlement, stock is removed from the account for clearing corp. 50 and placed into the borrower's account, and collateral (cash) is removed from the account for clearing corp. 50 and placed into the lender's account. These phases occur substantially simultaneously. The net result of settlement is that the borrower's account gets the stock and the lender's account gets the collateral.

At step 230, depository corp. 60 sends a notice of the settled transactions to clearing corp. 50, NCM-Borrower and NCM-Lender. If the trade has not settled, then depository corp. 60 sends a settlement fail notice to clearing corp. 50.

At step 232, clearing corp. 50 determines whether the trade has settled based on the notice received from depository corp. 60. If the trade has not settled by the time that depository corp. 60 finishes its end-of-day settlement, the trade is discarded. More specifically, clearing corp. 50 sends an error message back to middle office gateway 728 of middle office module 720 of ELMS 200, and deletes the trade. If the trade has settled, clearing corp. 50 performs a novation in which clearing corp. 50, as agent for the principal ELMS 200, interposes itself between the lender and the buyer. Novation is a legal term for the replacement of one contract with another; in this case, the agreement between the lender and the buyer is replaced by two agreements: a first agreement between the lender and clearing corp. 50, and a second agreement between the borrower and clearing corp. 50. After the novation, the lender and borrower are not legally obligated to each other under SEC rules adopted to allow ELMS 200 to operate.

Clearing corp. 50 is a central clearing party, serving to centralize credit risk in itself. If a lender or borrower goes out of business, it does not matter to the original counterparty, as clearing corp. 50 is responsible for the stock loan. Accordingly, borrowers and lenders can be anonymous to each other in ELMS 200: Since every clearing member's counterparty is clearing corp. 50, it does not matter who the original counterparty was, and so the original counterparty can be anonymous with no risk from the anonymity. ELMS 200 assigns recalls and returns, so the NCMs and CMs do not need to know the counterparty in their original transaction.

However, if a lender or borrower goes out of business, it does matter to the original associated clearing member. There is no anonymity between a NCM and its CM.

If the NCM defaults, its associated CM steps into a second lien on its margin collateral (clearing corp. 50 has the first lien) and closes relevant positions against clearing corp. 50 with assistance from ELMS 200.

If the CM defaults, its associated NCM steps into a second lien on its margin collateral (clearing corp. 50 has the first lien), and closes relevant positions against clearing corp. 50 with assistance from ELMS 200, such as recalling shares or executing buy-ins. In another embodiment, instead of closing the relevant positions, clearing corp. 50 transfers them to a solvent CM.

In contrast, in conventional bilateral (non-anonymous) stock loans, the borrower and seller are in contractual privity with each other, so they have to worry about each others' creditworthiness.

In the process depicted in FIG. 4, clearing corp. 50 guarantees rebates and cash dividends, which are not guaranteed in the conventional bilateral clearing and settlement of stock loans. Clearing corp. 50 also guarantees the post-settlement mark-to-market of stock loans, as in the conventional Hedge Program.

Clearing corp. 50 also guarantees buy-ins and sell-outs, discussed below.

Clearing corp. 50 now forwards to middle office 720 the result of the novation, a pair of symmetric trades: (i) a loan from a CM to ELMS 200 with clearing corp. 50 as agent, and (ii) a borrow to a CM from ELMS 200 with clearing corp. 50 as agent.

At step 233, ELMS 200 receives the result of the novation from clearing corp. 50.

At step 234, CM-Lender receives the settlement notice from depository corp. 60, with clearing corp. 50 as counterparty. At step 236, CM-Lender delivers the cash collateral to NCM-Lender. At step 238, NCM-Lender receives the cash collateral for its stock loan with clearing corp. 50 as counterparty.

At step 240, CM-Borrower receives the settlement notice from depository corp. 60, with clearing corp. 50 as counterparty. At step 242, CM-Borrower delivers the stock to NCM-Borrower. At step 244, NCM-Borrower receives the stock for its stock loan with clearing corp. 50 as counterparty.

FIG. 4B depicts the end-of-day margin netting performed by clearing corp. 50.

At step 250, clearing corp. 50 nets the margin requirements for all lenders and borrowers, and drafts (debits) their accounts for cash. For clarity, only activity for the NCM-Lender and NCM-Borrower are shown in FIG. 4B. At step 251, clearing corp. 50 sends margin requirement notices to NCM-Lender and NCM-Borrower, if their sub-accounts are in cash deficit relative to the amount that should be there after netting.

At step 252, NCM-Lender receives the margin requirement notice from clearing corp. 50. At step 254, NCM-Lender posts margin in its sub-account with clearing corp. 50.

In one embodiment, NCM-Lender maintains a bank account in its own name, and clearing corp. 50 has draft capabilities on this bank account up to the margin required for NCM-Lender's sub-account with clearing corp. 50.

At step 253, NCM-Borrower receives the margin requirement notice from clearing corp. 50. At step 255, NCM-Borrower posts margin in its sub-account with clearing corp. 50.

At step 260, clearing corp. 50 receives the posted margin from NCM-Lender and NCM-Borrower. If the sub-accounts remain in cash deficit after a specified time, such as 9 a.m. on the next day, the sub-account is determined to be in default.

In the conventional securities lending environment depicted in FIG. 1, an agent-lender, acting on behalf of a beneficial owner of securities, indemnifies the beneficial owner against the borrower failing to return securities. In the securities lending environment of FIG. 4, clearing corp 50. indemnifies the agent-lender against a borrower's failure to return securities, so the agent lender can reduce or eliminate its indemnification insurance against risk of counter-party failure due to clearing corp. 50 being the counter-party to all trades.

FIGS. 5A-5C are diagrams showing the legal relationships for a stock loan.

FIG. 5A shows a conventional situation where the borrower and lender are represented by respective broker-dealers. Contract A1 is between the lender and its broker dealer. Contract A2 is between the lender's broker-dealer and the borrower's broker-dealer. Contract A3 is between the borrower and its broker-dealer. The various parties are each principals to the contracts. In the United States, the form of the contract is the MSLA.

FIG. 5B shows the result of anonymous stock loan formation through ELMS 200. The situation is as in FIG. 5A except that contract A2 has been replaced by contract B2 between the lender's broker-dealer and clearing corp. 50 and contract B3 between the borrower's broker-dealer and clearing corp. 50. ELMS 200 maintains these records.

FIG. 5C shows the result of a default by the lender's broker-dealer, CM-Lender, according to one embodiment. Here, contract A1 and contract B2 are replaced by contract C1 between the lender and clearing corp. 50. Because NCM-Lender has not met the requirements of clearing corp. 50, this situation cannot be sustained, but it is acceptable in the event of the crisis of a default by CM-Lender for the purpose of quickly terminating the transactions of CM-Lender in an orderly manner.

The “own account” trades for the defaulting CM-Lender are manually processed by clearing corp. 50, usually by issuing recalls to the other side of the trade. In another embodiment, ELMS 200 automatically issues recalls for the other side of the “own account” trades of the defaulting CM-Lender.

FIGS. 6A-6B are diagrams showing the relationship between a clearing member account and its associated sub-accounts, and have been discussed above. Clearing corp. 50 usually uses sub-accounts to (i) deduct exchange fees, (ii) adjust mark-to-market payments, (iii) assess margin requirements, and (iv) apply cash debits.

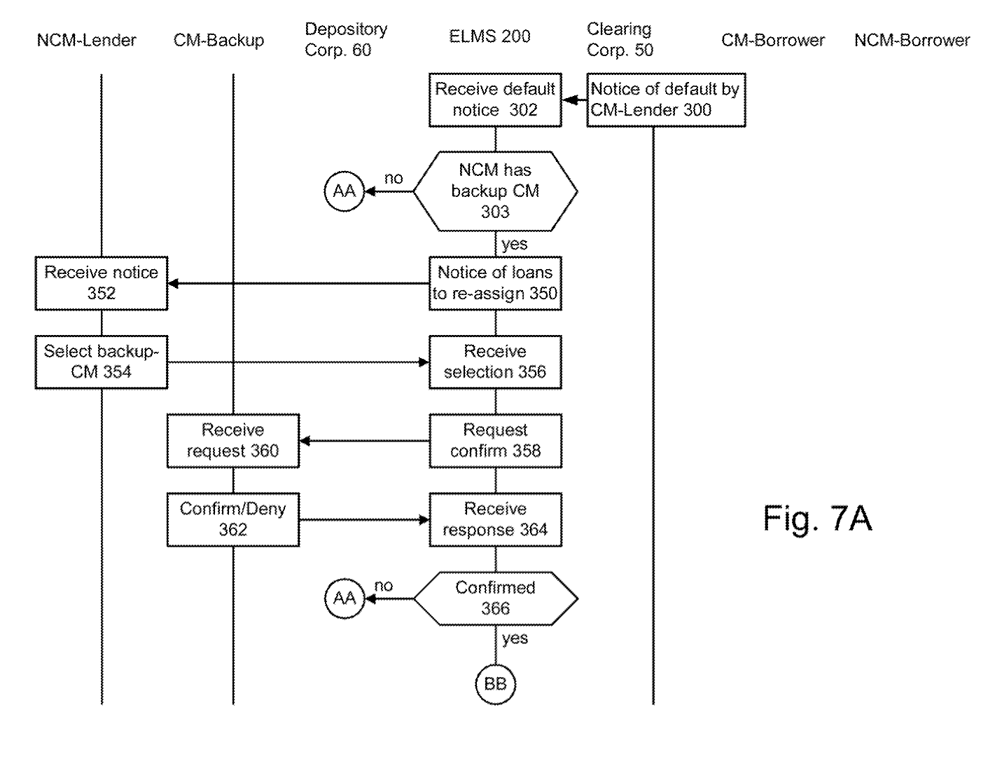

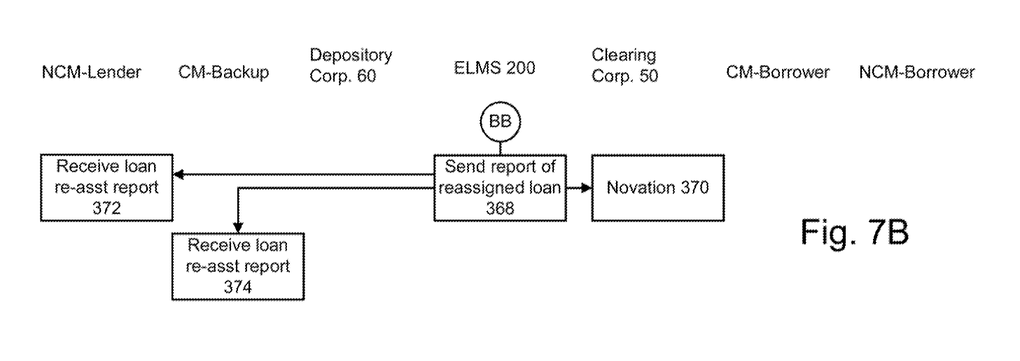

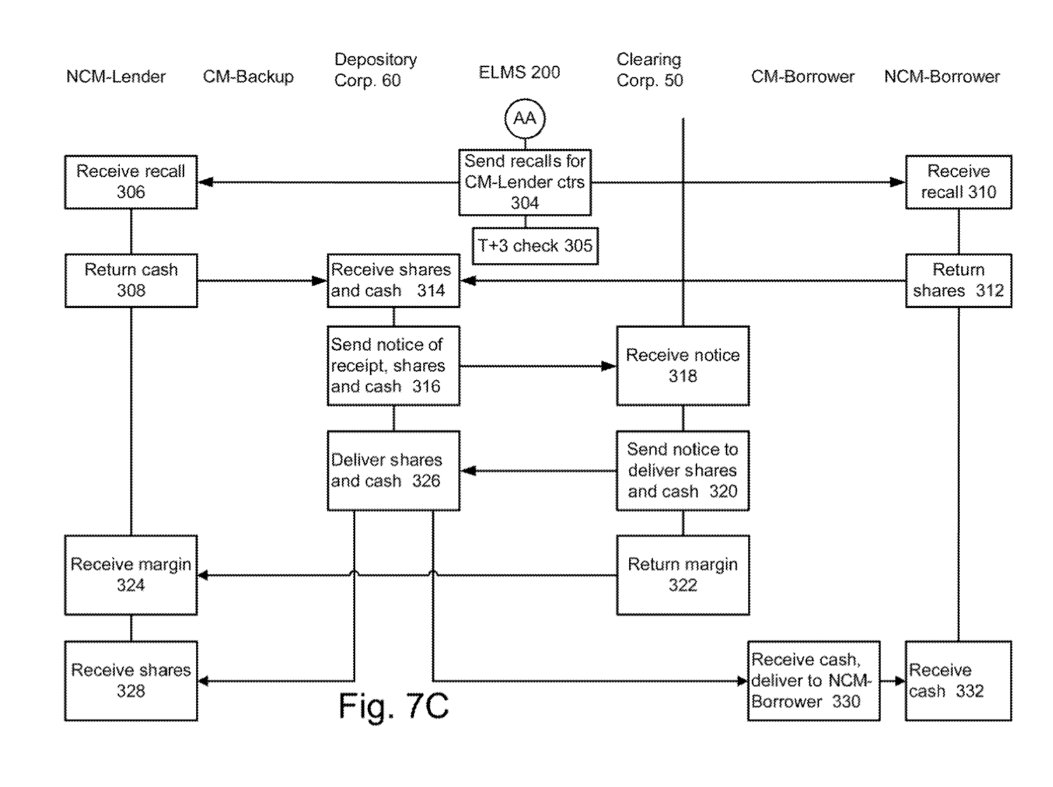

FIGS. 7A-7C, collectively referred to as FIG. 7, are a flowchart showing processing when a clearing member default occurs. Generally, FIG. 7A shows how ELMS 200 determines whether to re-assign the loans to another clearing member or to close out the loans; FIG. 7B shows the re-assignment, and FIG. 7C shows the close-out.

Assume that CM-Lender has defaulted, and clearing corp. 50 has determined, pursuant to its procedures, that the default has occurred.

At step 300, clearing corp. 50 sends a notice of default of CM-Lender to ELMS 200.

At step 302, ELMS 200 receives the notice of default.

At step 303, ELMS 200 checks its records to determine which loans CM-Lender is responsible for, including CM-Lender's “own account” loans and associated NCM loans. For each of these loans, ELMS 200 checks whether there is at least one backup CM available. Typically, when an NCM registers with a CM, the NCM designates its backup CMs. The backup CMs are maintained in stored information in middle office database 726, in association with the NCM. In another embodiment, an NCM designates its backup CM for each stock loan, as one of the terms in loan formation. If there is no backup CM, processing continues at step 304 in FIG. 7C.

If ELMS 200 determines that NCM may have a backup CM, then at step 350, ELMS 200 sends a notice of loans that need to be assigned to a different CM due to the default of CM-Lender. At step 352, NCM-Lender receives the notice of loans that need to be re-assigned. At step 354, for each loan, NCM-Lender selects a new CM to replace the defaulted CM-Lender. In some embodiments, NCM-Lender ranks a set of new CMs in order of preference, on a loan by loan basis or for its portfolio of loans. NCM-Lender sends its selected backup CM(s) to ELMS 200.

At step 356, ELMS 200 receives the selection of backup CM(s) from NCM-Lender. At step 358, ELMS 200 sends a confirmation request to each of the backup CMs, to ensure they will serve as the CM for the loan. At step 360, the selected CM(s) receive the notice(s), and at step 362, the selected CM(s) reply to ELMS 200 to confirm or deny their interest in serving as CM for the loans; the confirm/deny may be on a loan-by-loan basis or for the entire offered portfolio of loans.

At step 364, ELMS 200 receives the response. If it is a deny, and there is an additional potential backup CM selected by NCM-Lender, then ELMS 200 sends a notice to such CM (not shown in FIG. 7, for clarity, but similar to steps 358, 360, 362). Eventually, all loans have been either confirmed by a new CM, or remain without a new CM. For each loan, at step 366, ELMS 200 determines whether it has been confirmed by a new CM. If the loan has been confirmed by a new CM, processing continues at step 368 in FIG. 7B. If the loan has not been confirmed by a new CM, processing continues at step 304 in FIG. 7C.

Turning to FIG. 7B, at step 368, ELMS 200 sends a report of the reassigned loan to clearing corp. 50, NCM-Lender and the confirmed new CM, also referred to as CM-Backup. It will be recalled that clearing corp. 50 is a central clearing party for stock loans formed using ELMS 200.

At step 370, clearing corp. 50 performs a novation, substituting CM-Backup for the defaulted CM-Lender, and business continues as usual. Note that the NCM-Borrower and CM-Borrower were not involved at all, so they have been entirely shielded from the defaulted CM-Lender, which makes their business flow much smoother than the conventional arrangement involving SIPC and so on.

At step 372, NCM-Lender receives the loan reassignment report. At step 374, CM-Backup receives the loan reassignment report.

Turning to FIG. 7C, the goal is to quickly terminate the loans associated with the defaulted CM-Lender that were not reassigned to new CM(s), as the associated NCMs are stranded by the default from the viewpoint of clearing corp. 50. The objective is to keep these loans out of the bankruptcy proceeding for the CM-Lender; which is fair because the CM-Lender's only interest in the loan was its fee for acting as the CM. The procedure described below thus functions as a risk reduction mechanism for the NCMs associated with the CM.

At step 304, ELMS 200 checks its records to determine which loans CM-Lender is responsible for, including CM-Lender's “own account” loans and associated NCM loans but not including any loans that have been re-assigned to other clearing members. ELMS 200 sends “close-out recall” notices to the lenders and borrowers for all of these loans. A normal recall is initiated by the real lender, whereas a “close-out recall” is an artificial event using the existing recall procedure and the existing procedure for recovering collateral.

In this embodiment, “own account” loans and non-re-assigned associated NCM loans are processed similarly. In other embodiments, “own account” loans are processed differently than non-re-assigned associated NCM loans.

In one embodiment, ELMS 200 selects the counterparties involved in the original transactions. In another embodiment, ELMS 200 selects the counterparties for the loans being terminated according to a procedure for incentivizing NCMs and CMs to behave in a desired manner, described in detail in U.S. patent application Ser. No. 12/217,456, filed Jul. 2, 2008, having common inventors herewith, the disclosure of which is hereby incorporated by reference in its entirety.

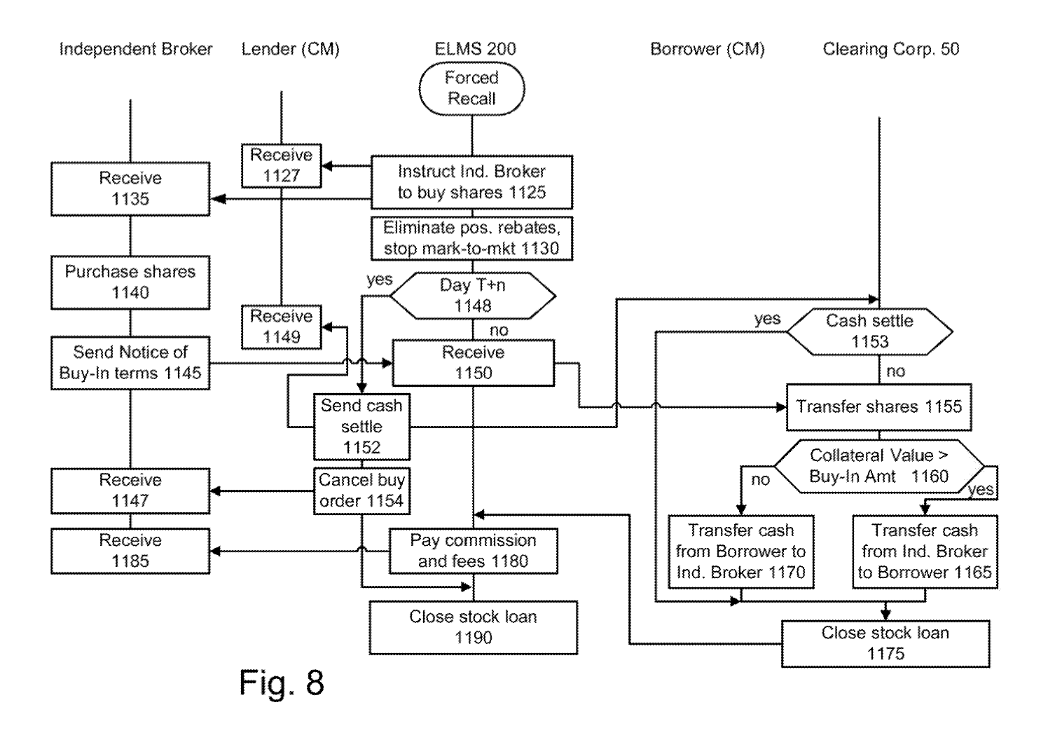

At step 305, on day T+3 after the recall, ELMS 200 checks whether the shares have been returned by NCM-Borrower; if so, no response is needed. If not, ELMS 200 performs a forced buy-in, discussed below with regard to FIG. 8.

In some embodiments, the recall process is omitted and ELMS 200 immediately performs a forced buy-in.

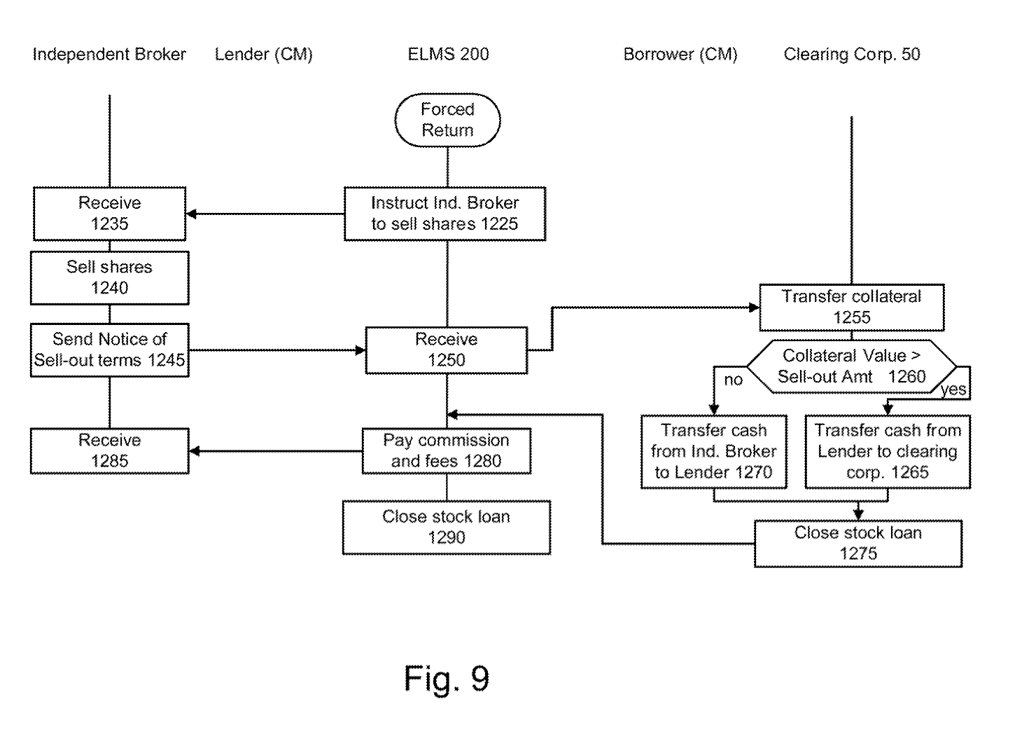

At step 305, on day T+3 after the recall, ELMS 200 checks whether the cash collateral has been returned by NCM-Lender; if so, no response is needed. If not, in response to a determination of default by clearing corp. 50, ELMS 200 performs a forced sell-out, discussed below with regard to FIG. 9. That is, when NCM-Lender defaults, its margin collateral is frozen with any shortfall being funded by the defaulting NCM-Lender and guaranteed by clearing corp. 50, and a “close-out recall” is used to recall shares from a borrower. In one embodiment, ELMS 200 assigns the recall to the actual borrower involved in the original transaction. In another embodiment, ELMS 200 assigns the recall according to a procedure for incentivizing NCMs and CMs to behave in a desired manner, described in detail in U.S. patent application Ser. No. 12/217,456.

In this embodiment, clearing corp. 50 provides a “sponsored membership” to the NCMs associated with the defaulted CM, enabling the orderly close-out of the loan.

At step 306, NCM-Lender receives the recall notice. At step 308, NCM-Lender returns its cash collateral to depository corp. 60 and notifies ELMS 200 that it has returned its cash collateral.

At step 310, NCM-Borrower receives the recall notice. At step 312, NCM-Borrower returns its shares to depository corp. 60 and notifies ELMS 200 that it has returned its shares.

At step 314, depository corp. 60 receives the recalled shares and cash collateral. At step 316, depository corp. 60 notifies clearing corp. 50 that the shares and collateral have been returned.

At step 318, clearing corp. 50 receives the notice from depository corp. 60 that the shares and collateral have been returned. Clearing corp. 50 then determines where the shares and collateral should be delivered. In one embodiment, ELMS 200 identifies the original counterparties to clearing corp. 50. In another embodiment, ELMS 200 identifies the counterparties according to its incentivizing procedure, described in detail in U.S. patent application Ser. No. 12/217,456. At step 320, clearing corp. 50 sends notices instructing depository corp. 60 as to which accounts the shares and collateral should be delivered to.

At step 322, assuming NCM-Lender has only one loan, clearing corp. 50 returns the margin corresponding to the just terminated loan to NCM-Lender. If NCM-Lender has more than one loan, the margin is completely returned only when all NCM-Lender's loans are terminated.

At step 326, depository corp. 60 receives the delivery instructions from clearing corp. 50, delivers the shares to the depository account of NCM-Lender, and delivers the cash collateral to CM-Borrower.

At step 324, NCM-Lender receives the returned margin from clearing corp. 50.

At step 328, NCM-Lender receives the recalled shares from the depository account of clearing corp. 50 directly, that is, the recalled shares are not passed through the depository account of the defaulted CM-Borrower.

At step 330, CM-Borrower receives the returned cash collateral, and delivers it to NCM-Borrower.

At step 332, NCM-Borrower receives the returned cash collateral.

FIG. 8 is a flowchart showing forced buy-in processing.

A Buy-in is an action whereby collateral held versus a loan is seized and new shares are purchased on the open market. In the context of a defaulted CM, ELMS 200 executes a buy-in after a forced recall when the shares have not been returned by the borrower; or in some cases, executes a buy-in directly, leaving the original loan shares undisturbed and in the possession of the borrower. If there are losses relative to the loan's collateral from the buy-in, the losses are satisfied from the margin collateral of the non-performing party.

At step 1125, ELMS 200 sends an instruction to an independent broker to purchase stock to satisfy the share recall of the lender. The borrower is responsible for all fees related to the buy-in and any shortfall related to the buy-in. If there is a surplus after completion of buy-in and associated fees, it is returned to the borrower. If the stock cannot be bought in the open market, the independent broker continues trying until the stock can be bought. ELMS 200 also notifies the lender of the buy-in.

At step 1127, the lender receives notice of the buy-in instruction.

At step 1130, ELMS 200 sets all positive rebate rates to zero and all negative rebate rates are left alone, and mark-to-market activity for this loan ceases.

At step 1135, the independent broker receives the purchase instruction from ELMS 200.

At step 1140, the independent broker purchases the shares. This may occur immediately, or may take days to occur. The buy-in occurs when the independent broker purchases the shares.

At step 1145, the independent broker notifies ELMS 200 of the terms of the forced share purchase (buy-in).

At step 1148, ELMS 200 checks whether the cash settlement day, T+n, has arrived without a buy-in. If not, processing continues at step 1150. If so, at step 1152, ELMS 200 sends a cash settlement notice to clearing corp. 50, and at step 1154, ELMS 200 sends a buy order cancellation to the independent broker, and processing continues at step 1190.

At step 1147, the independent broker receives the cancellation of the buy order and terminates its efforts to buy.

At step 1149, the lender receives notice of the cash settlement instruction, so that the lender can demonstrate compliance with the close-out requirement of SEC Rule 204T.

At step 1150, ELMS 200 receives the buy-in notice from the independent broker, and sends the buy-in information to clearing corp. 50. At this point, ELMS 200 knows that shares have been found to satisfy the recall notice of the lender.

At step 1153, clearing corp. 50 receives the cash settlement notice from ELMS 200. When a cash settlement occurs, clearing corp. 50 determines a cash settlement value for the loaned stock that was not returned from the borrower to the lender. If the collateral exceeds the cash settlement value, the excess is paid to the borrower. If the collateral is less than the cash settlement value, clearing corp. 50 pays the deficiency to the lender, and the borrower pays the deficiency to clearing corp. 50. Processing continues at step 1175. If a cash settlement does not occur, processing continues at step 1155.

At step 1155, clearing corp. 50 transfers the shares from the independent broker to clearing corp. 50 acting as agent for ELMS 200, and then transfers the shares from clearing corp. 50 acting as agent for ELMS 200 to the lender.

At step 1160, clearing corp. 50 checks whether the value of the collateral for the stock loan, adjusted for commissions and fees, exceeds the buy-in amount, that is, the price that the independent broker paid for the shares.

If the adjusted value of the collateral for the stock loan exceeds the buy-in amount, then at step 1165, clearing corp. 50 transfers cash from the independent broker to clearing corp. 50 acting as agent for ELMS 200, and then transfers cash from clearing corp. 50 acting as agent for ELMS 200 to the borrower.

If the adjusted value of the collateral for the stock loan is less than the buy-in amount (deficit cash), then at step 1170, clearing corp. 50 transfers cash from the borrower to clearing corp. 50 acting as agent for ELMS 200, and then transfers cash from clearing corp. 50 acting as agent for ELMS 200 to the independent broker. When NCM-Borrower is the non-performing party, that is, did not return their recalled stock, clearing corp. 50 uses the margin in the sub-account for NCM-Borrower to provide the deficit cash.

At step 1175, clearing corp. 50 closes the loan and sends a notice to ELMS 200 that clearance has occurred.

At step 1180, ELMS 200 pays commissions and fees to the independent broker, and debits the borrower for the amounts of the commissions and fees.

At step 1185, the independent broker receives the commissions and fees. At step 1190, after the stock is provided, the stock loan is closed and collateral and any fees are settled.

FIG. 9 is a flowchart showing forced sell-out processing.

A sell-out is an action, triggered by the failure by NCM-Lender to return collateral, whereby shares, that were returned from a loan, are sold on the open market.

At step 1225, ELMS 200 sends an instruction to an independent broker to sell the recently returned stock to provide funds for collateral. The lender is responsible for all fees related to the sell-out and any shortfall related to the sell-out. If there is a surplus after completion of sell-out and associated fees, it is returned to the lender.

At step 1235, the independent broker receives the purchase instruction from ELMS 200.

At step 1240, the independent broker sells the shares. This may occur immediately, or may take days to occur. The sell-out occurs when the independent broker sells the shares.

At step 1245, the independent broker notifies ELMS 200 of the terms of the forced share sale (sell-out).

At step 1250, ELMS 200 receives the sell-out notice from the independent broker, and sends the sell-out information to clearing corp. 50. At this point, ELMS 200 knows that some funds have been found to satisfy the collateral for the return notice of the borrower.

At step 1255, clearing corp. 50 transfers the share sale funds from the independent broker to clearing corp. 50 acting as agent for ELMS 200, and then transfers the share sale funds from clearing corp. 50 acting as agent for ELMS 200 to the borrower.

At step 1260, clearing corp. 50 checks whether the value of the collateral for the stock loan, adjusted for commissions and fees, exceeds the sell-out amount, that is, the price for which the independent broker sold the shares.

If the adjusted value of the collateral for the stock loan exceeds the sell-out amount, then at step 1265, clearing corp. 50 transfers cash from the lender to clearing corp. 50 acting as agent for ELMS 200, and then transfers cash from clearing corp. 50 acting as agent for ELMS 200 to the borrower.

If the adjusted value of the collateral for the stock loan is less than the sell-out amount (deficit cash), then at step 1270, clearing corp. 50 transfers cash from the independent broker to clearing corp. 50 acting as agent for ELMS 200, and then transfers cash from clearing corp. 50 acting as agent for ELMS 200 to the lender. The deficit cash is supplied from the non-performing party's margin account; here, assume that NCM-Lender is the non-performing party, and so the margin for its sub-account at clearing corp. 50 supplies the deficit cash.

At step 1275, clearing corp. 50 closes the loan and sends a notice to ELMS 200 that clearance has occurred.

At step 1280, ELMS 200 pays commissions and fees to the independent broker, and debits the lender for the amounts of the commissions and fees.

At step 1285, the independent broker receives the commissions and fees. At step 1290, after the stock is provided, the stock loan is closed and collateral and any fees are settled.

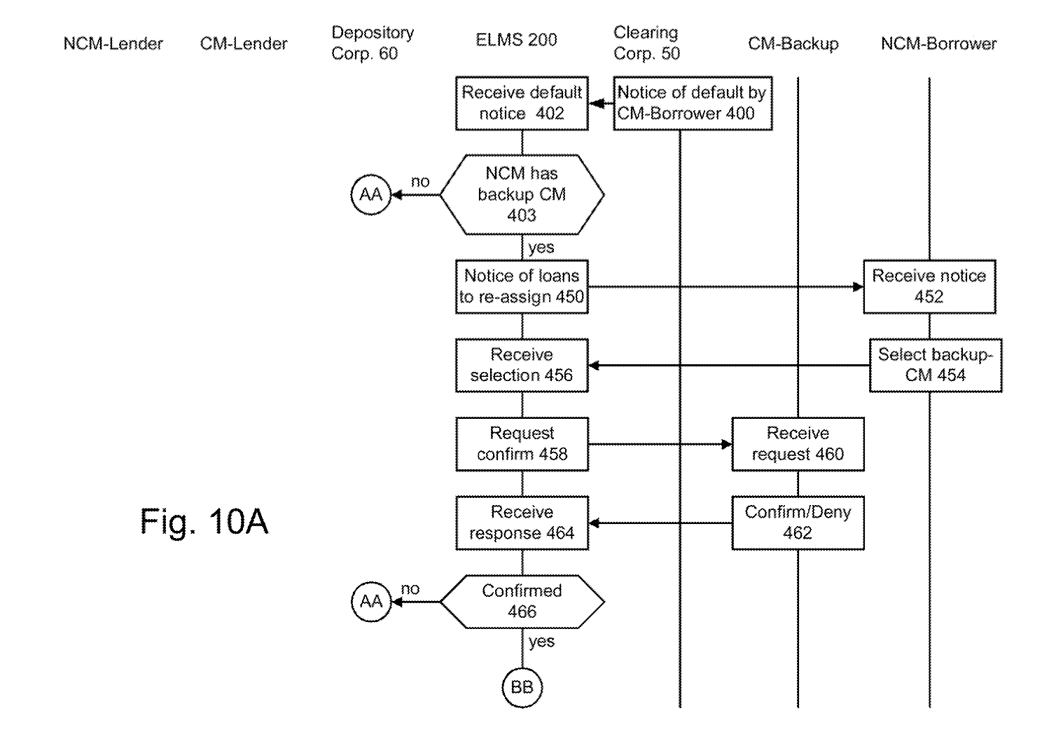

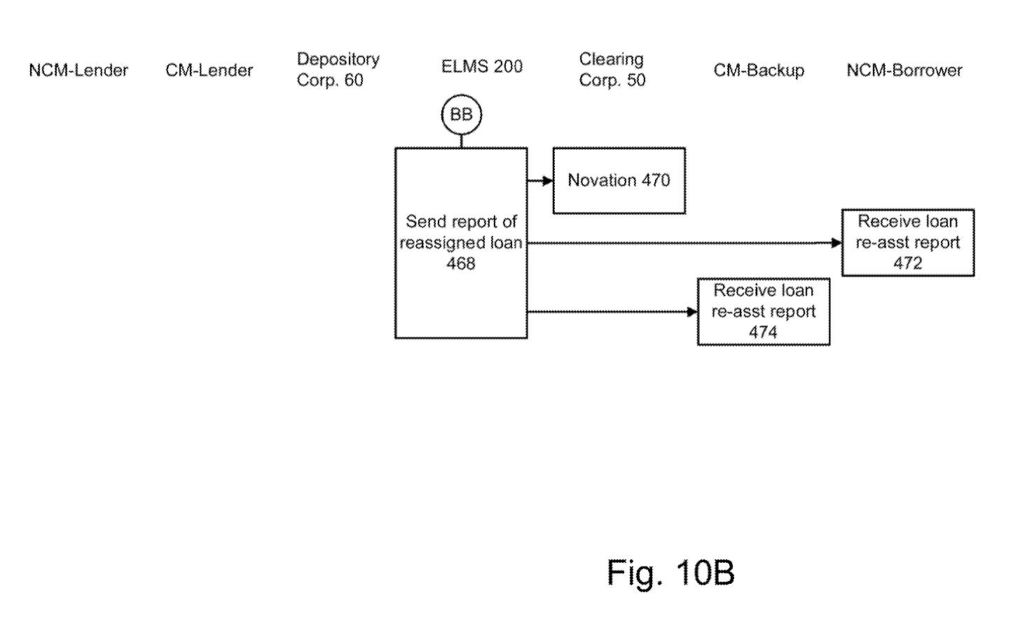

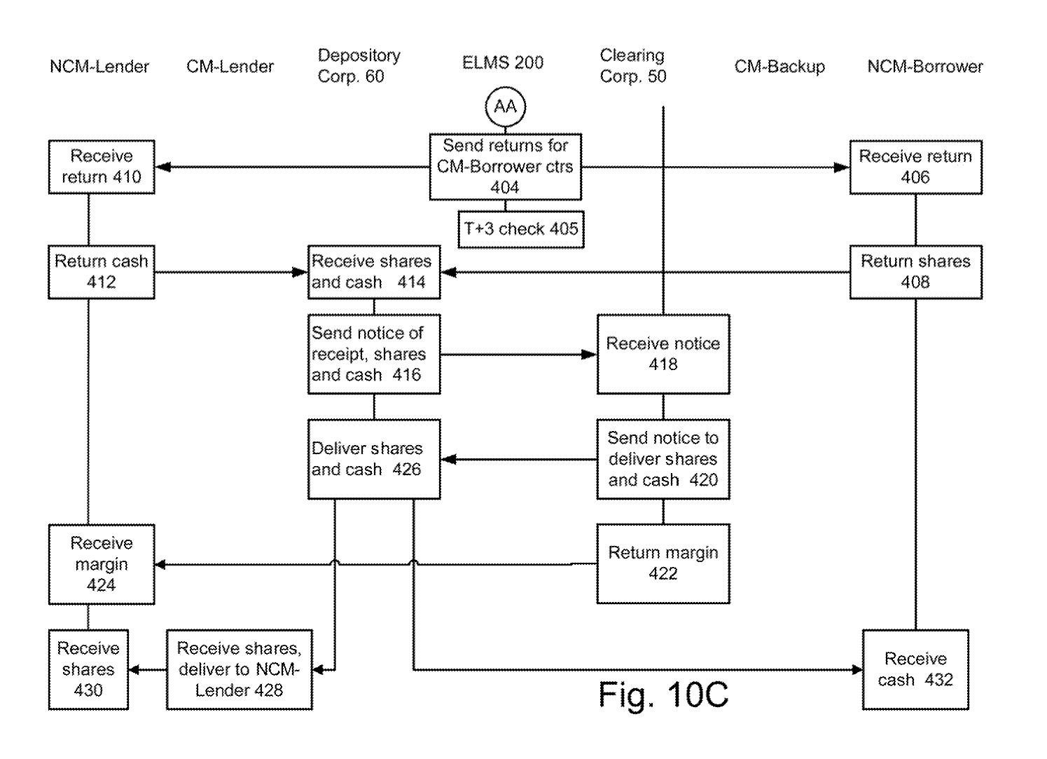

FIGS. 10A-10C, collectively referred to as FIG. 10, are a flowchart showing the scenario of a default by CM-Borrower. FIG. 10A generally corresponds to FIG. 7A, and shows how ELMS 200 determines whether to re-assign the loans to another clearing member or to close out the loans; FIG. 10B generally corresponds to FIG. 7B, and shows the re-assignment, and FIG. 10C shows the close-out. FIGS. 10A and 10B will not be discussed for brevity.

Turning to FIG. 10C, the goal is to quickly terminate the loans associated with the defaulted CM-Borrower that were not reassigned to new CM(s), as discussed above with regard to FIG. 7C.

At step 404, ELMS 200 checks its records to determine which loans CM-Borrower is responsible for, including CM-Borrower's “own account” loans and associated NCM loans but not including any loans that have been re-assigned to other clearing members. ELMS 200 sends “close-out return” notices to the lenders and borrowers for all of these loans. A normal return is initiated by the real borrower, whereas a “close-out return” is an artificial event using the existing return procedure and the existing procedure for recovering shares.

In one embodiment, ELMS 200 assigns the return to the actual lender involved in the original transaction. In another embodiment, ELMS 200 assigns the return according to a procedure for incentivizing NCMs and CMs to behave in a desired manner, described in detail in U.S. patent application Ser. No. 12/217,456, filed Jul. 2, 2008, having common inventors herewith, the disclosure of which is hereby incorporated by reference in its entirety.

In this embodiment, “own account” loans and non-re-assigned associated NCM loans are processed similarly. In other embodiments, “own account” loans are processed differently than non-re-assigned associated NCM loans.

At step 405, on day T+3 after the recall, ELMS 200 checks whether the shares have been returned; if so, no response is needed. If not, ELMS 200 performs a forced buy-in, discussed above with regard to FIG. 8.

At step 405, on day T+3 after the recall, ELMS 200 checks whether the cash collateral has been returned; if so, no response is needed. If not, in response to a determination of default by clearing corp. 50, ELMS 200 performs a forced sell-out, discussed above with regard to FIG. 9.

In another embodiment, clearing corp. 50 provides a “sponsored membership” to NCM-Borrower to avoid a forced return, enabling the orderly close-out of the loan.

At step 406, NCM-Borrower receives the return notice. At step 408, NCM-Borrower returns its shares to depository corp. 60 and notifies ELMS 200 that it has returned its shares.

At step 410, NCM-Lender receives the return notice. At step 212, NCM-Lender returns its collateral (cash) to depository corp. 60 and notifies ELMS 200 that it has returned its collateral.

At step 414, depository corp. 60 receives the returned shares and cash collateral. At step 316, depository corp. 60 notifies clearing corp. 50 that the shares and collateral have been returned.

At step 418, clearing corp. 50 receives the notice from depository corp. 60 that the shares and collateral have been returned. Clearing corp. 50 then determines where the shares and collateral should be delivered. In one embodiment, ELMS 200 identifies the original counterparties to clearing corp. 50. In another embodiment, ELMS 200 identifies the counterparties according to its incentivizing procedure, described in detail in U.S. patent application Ser. No. 12/217,456. At step 420, clearing corp. 50 sends notices instructing depository corp. 60 as to which accounts the shares and collateral should be delivered to.

At step 422, clearing corp. 50 returns the margin corresponding to the just terminated loan to NCM-Lender.

At step 426, depository corp. 60 receives the delivery instructions from clearing corp. 50, delivers the collateral to the depository account of NCM-Borrower, and delivers the shares to CM-Lender.

At step 424, NCM-Lender receives the returned margin from clearing corp. 50.

At step 428, CM-Lender receives the returned shares, and delivers them to NCM-Lender.

At step 430, NCM-Lender receives the returned shares.

At step 432, NCM-Borrower receives the returned collateral from the depository account of clearing corp. 50 directly, that is, the returned collateral is not passed through the depository account of the defaulted CM-Borrower.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for processing a stock loan having a non-clearing member associated with an original clearing member, comprising:
receiving, at a computer, a notice that the original clearing member has defaulted,
checking, by the computer, whether the non-clearing member has a backup clearing member,
when the non-clearing member has a backup clearing member, automatically reassigning, by the computer, the stock loan to the backup clearing member, and
when the non-clearing member lacks a backup clearing member, automatically terminating, by the computer, the stock loan.

2. The method of claim 1, further comprising requesting confirmation from the backup clearing member that it will accept the stock loan, and, prior to reassigning the stock loan, receiving confirmation from the backup clearing member that it will accept the stock loan.

3. The method of claim 1, wherein the checking includes sending a list of backup clearing members to the non-clearing member, and receiving a selected of a selected backup clearing member.

4. The method of claim 3, further comprising retrieving the list of backup clearing members from stored information associated with the non-clearing member.

5. The method of claim 1, further comprising sending a notice of the reassigned loan to a central clearing party so that the central clearing party novates the backup clearing member into the stock loan in place of the original clearing member.

6. The method of claim 1, wherein the termination is a recall when the non-clearing member is a lender, and the termination is a return when the non-clearing member is a borrower.

7. The method of claim 6, wherein the recall is a close-out recall and the return is a close-out return.

8. The method of claim 6, further comprising performing a forced buy-in when the loaned stock has not been returned after a predetermined time period.

9. The method of claim 6, wherein collateral was provided for the stock loan, and further comprising performing a forced sell-out when the collateral has not been returned after a predetermined time period.

10. A method for processing a stock loan having a non-clearing member associated with an original clearing member, comprising:
receiving, at a computer, a notice that the original clearing member has defaulted, and
automatically reassigning, by the computer, the stock loan to a backup clearing member.

11. The method of claim 10, further comprising requesting confirmation from the backup clearing member that it will accept the stock loan, and, prior to reassigning the stock loan, receiving confirmation from the backup clearing member that it will accept the stock loan.

12. The method of claim 10, further comprising sending a list of backup clearing members to the non-clearing member, and receiving a selection of a selected backup clearing member.

13. The method of claim 12, further comprising retrieving the list of backup clearing members from stored information associated with the non-clearing member.

14. The method of claim 10, further comprising sending a notice of the reassigned loan to a central clearing party so that the central clearing party novates the backup clearing member into the stock loan in place of the original clearing member.

15. A method for processing a stock loan having a non-clearing member associated with an original clearing member, comprising:
receiving, at a computer, a notice that the original clearing member has defaulted,
automatically terminating, by the computer, the stock loan.

16. The method of claim 15, wherein the termination is a recall when the non-clearing member is a lender, and the termination is a return when the non-clearing member is a borrower.

17. The method of claim 16, wherein the recall is a close-out recall and the return is a close-out return.

18. The method of claim 16, further comprising performing a forced buy-in when the loaned stock has not been returned after a predetermined time period.

19. The method of claim 16, wherein collateral was provided for the stock loan, and further comprising performing a forced sell-out when the collateral has not been returned after a predetermined time period.
